(19) United States
(12) Patent Application Publication
(10) Pub. No.: US 2012/0081738 A1
(43) Pub. Date: Apr. 5, 2012

(54) JOB EXECUTION SYSTEM, JOB RECEIVING APPARATUS AND COMPUTER-READABLE MEDIUM

(75) Inventor: Noriaki SEKI, Kanagawa (JP)

(73) Assignee: FUJI XEROX CO., LTD., Tokyo (JP)

(21) Appl. No.: 13/111,496

(22) Filed: May 19, 2011

(30) Foreign Application Priority Data
Oct. 5, 2010 (JP) 2010-225720

(51) Int. Cl. G06K 15/02

(52) U.S. Cl. 358/1.15

(57) ABSTRACT

A job execution system includes one or more transmission apparatuses and a job receiving apparatus. The one or more transmission apparatuses add identification information for identifying a group of jobs to be executed in succession to a job and transmit an execution request of the job. The job receiving apparatus receives the transmitted execution request of the job. The job receiving apparatus includes a job queue and a job registration unit. The job registration unit makes a correspondence between the received execution request and the identification information, and registers said received execution request and said identification information in the job queue. When the received execution request has the same identification information which is previously registered in the job queue, the job registration unit registers the received execution request immediately after another execution request of a job having the same identification information.

### CROSS-REFERENCE TO RELATED APPLICATION

This application is based on and claims priority under 35 USC 119 from Japanese Patent Application No. 2010-225720 filed on Oct. 5, 2010.

### BACKGROUND

### Technical Field

The present invention relates to a job execution system, a job receiving apparatus and a computer-readable medium.

### SUMMARY

[1] According to an aspect of the invention, a job execution system includes one or more transmission apparatuses and a job receiving apparatus. The one or more transmission apparatuses that add identification information for identifying a group of jobs to be executed in succession to a job and that transmits an execution request of the job with the identification information. The job receiving apparatus receives the execution request of the job transmitted by the transmission apparatus. The job receiving apparatus includes a job queue and a job registration unit. The job registration unit makes a correspondence between the received execution request of the job and the identification information added to the job, and registers said received execution request of the job and said identification information in the job queue. When the received execution request of the job has the same identification information which is previously registered in the job queue, the job registration unit registers the received execution request of the job immediately after another execution request of a job having the same identification information.

### BRIEF DESCRIPTION OF THE DRAWINGS

Exemplary embodiments of the invention will be described in detail based on the following figures, wherein:

FIG. 1 is an overall configuration drawing showing an embodiment of a job execution system according to the present invention;

FIG. 2 is a view showing an example of a hardware configuration of an image forming apparatus according to Embodiment 1;

FIG. 3 is a view showing an example of a hardware configuration of a server computer for accomplishing a queue management node according to Embodiment 1;

FIG. 4 is a block configuration diagram showing the job execution system according to Embodiment 1;

FIG. 5 is a flowchart showing job execution processing at the image forming apparatus according to Embodiment 1;

FIG. 6 is a flowchart showing job execution processing at the queue management node according to Embodiment 1;

FIGS. 7A and 7B are views illustrating the position of a new job to be registered in a job queue according to Embodiment 1;

FIG. 8 is a flowchart showing job execution processing at the queue management node according to Embodiment 2;

FIGS. 9A to 9D are views illustrating the position of a new job to be registered in a job queue according to Embodiment 2; and

FIGS. 10A to 10D are views illustrating the position of a new job to be registered in a job queue according to Embodiment 2.

### DETAILED DESCRIPTION

Preferable embodiments according to the present invention will be described below on the basis of the accompanying drawings.

### Embodiment 1

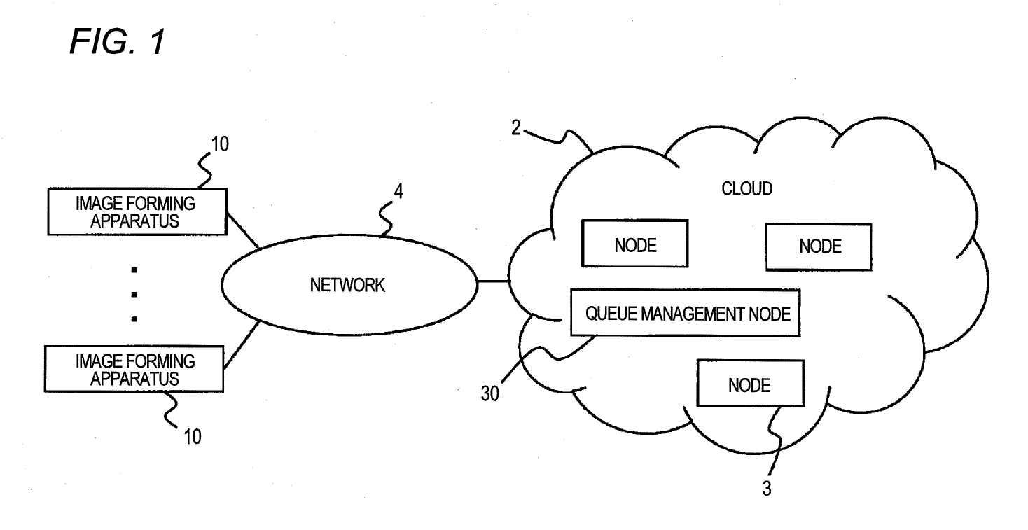

FIG. 1 is an overall configuration drawing showing an embodiment of a job execution system according to the present invention. FIG. 1 shows a configuration in which image forming apparatuses 10 are connected to a cloud 2 via a network 4. The image forming apparatus 10 is shown as an example of a transmission apparatus for transmitting job execution requests according to the present invention. The image forming apparatus 10 according to this embodiment serves as an apparatus having a plurality of functions, such as a scanner function and a printing function, and requests the cloud 2 to execute all or part of received jobs. The cloud 2, an abbreviation of cloud computing, executes jobs according to a job execution request from the image forming apparatus 10 and returns the result of the execution. The cloud 2 includes a queue management node 30 for receiving jobs requested to be executed and for managing the jobs using a job queue and one or more nodes 3 for executing the jobs. These nodes 30 and 3 are accomplished using a computer or part of a computer. FIG. 1 shows an example of a configuration of the job execution system. However, the type, number, connection configuration, etc. of each of apparatuses requesting the cloud 2 to execute jobs are not limited to those shown in the example. In addition, although one network, i.e., the network 4, is used in the configuration for the convenience of description, the connection configuration of the network 4 is not limited to that shown in the example shown FIG. 1, provided that the image forming apparatuses 10 can gain access to the cloud 2.

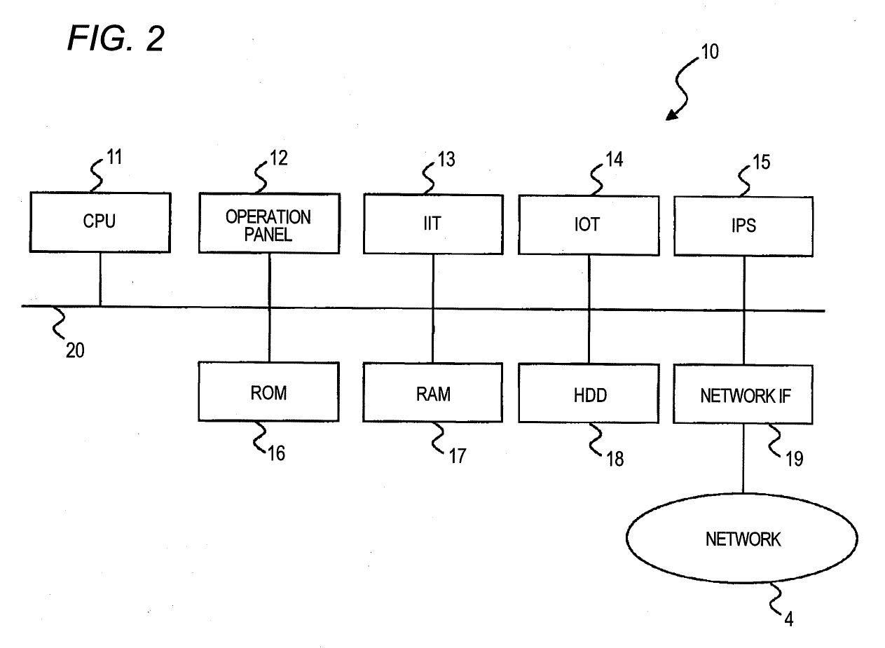

FIG. 2 is a view showing an example of a hardware configuration of the image forming apparatus 10 according to this embodiment. The image forming apparatus 10 is an apparatus equipped with various functions as described above and incorporating a computer. Referring to FIG. 2, a CPU 11 controls the operations of various devices mounted on this apparatus, such as an IIT (image input terminal) 13, an JOT (image output terminal) 14, according to programs stored in a ROM 16. The IIT 13 is an image input device that reads a manuscript set by the user and stores obtained data as electronic data in an HDD (hard disk drive) 18 or the like. The ITT 13 may be accomplished by a scanner, for example. The IOT 14, serving as an image output device, prints images on output paper according to instructions from control programs executed by the CPU 11. The IOT 14 may be accomplished by a printer, for example. An address data bus 20 is connected to various devices that are controlled by the CPU 11 to perform data communication. The operation panel 12 receives instructions from the user and indicates information. In this embodiment, a job is generated by input from the operation panel 12, and a job execution request is generated by performing a predetermined operation. An IPS (image processing system) 15, serving as an image processing apparatus, executes the processing of images contained in a received job. The ROM (read-only memory) 16 stores various programs regarding the control of this apparatus, encrypted electronic data and the transmission/reception of the electronic data. Various components described later carry out their predetermined functions when the various programs are executed. A RAM (random access memory) 17 is used as a work memory when programs are executed or as a communication buffer when electronic data is transmitted/received. In this embodiment, the RAM 17 may also be used as a job queue in the image forming apparatus 10. The HDD 18 stores electronic documents or the like read by the ITT 13. A network interface (IF) 19 is connected to the network 4 and used, for example, to transmit a job generated by this apparatus, to receive the result of execution of the job transmitted to this apparatus and to gain access to this apparatus via a browser. In this embodiment, the network interface 19 is used to exchange information between the apparatus and the cloud 2.

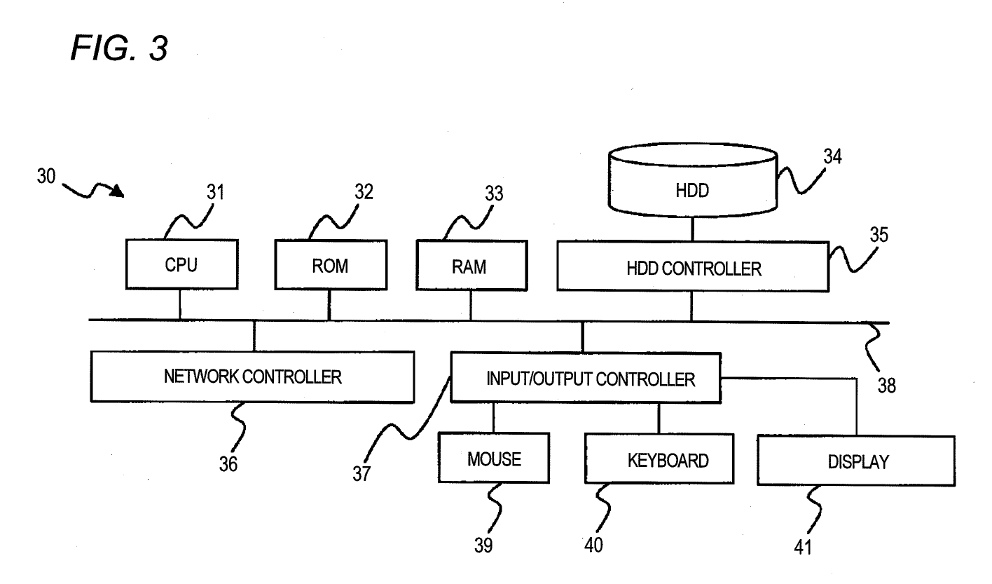

FIG. 3 is a view showing an example of a hardware configuration of a server computer for accomplishing the queue management node 30 according to this embodiment. The server computer according to this embodiment can be accomplished using a conventional general-purpose hardware configuration. More specifically, as shown in FIG. 3, the computer has a CPU 31, a ROM 32, a RAM 33, an HDD controller 35 to which a hard disk drive (HDD) 34 is connected, a network controller 36 provided as communication means, and an input/output controller 37, these being connected to an internal bus 38. A mouse 39 and a keyboard 40 serving as input means and a display 41 serving as a display device may also be connected to the input/output controller 37.

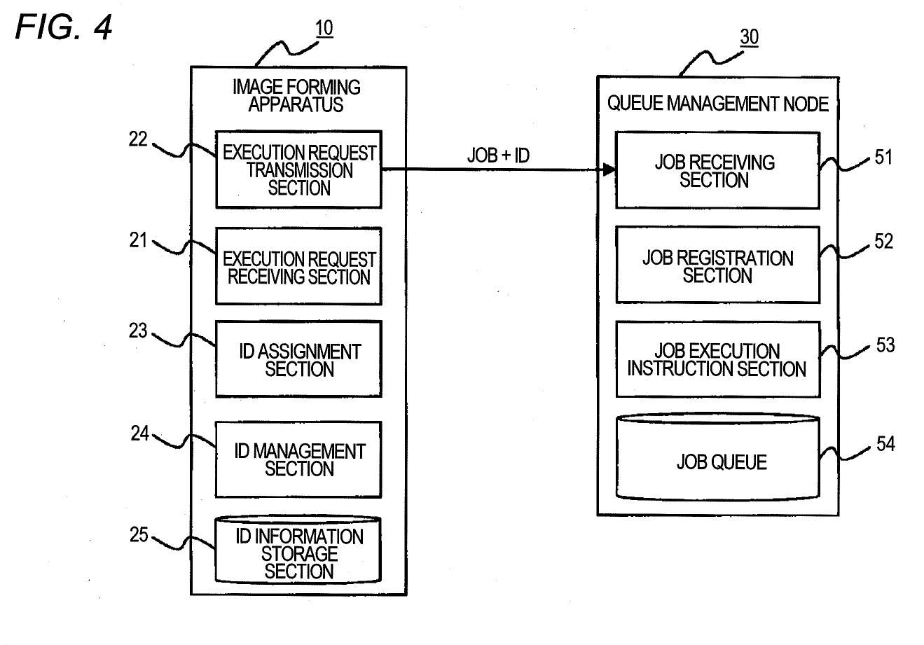

FIG. 4 is a block configuration diagram showing the job execution system according to this embodiment. The image forming apparatus 10 has an execution request receiving section 21, an execution request transmission section 22, an ID assignment section 23, an ID management section 24, and an ID information storage section 25. The execution request receiving section 21 receives a job execution request from the user. The execution request transmission section 22 transmits the job execution request to the queue management node 30. The ID assignment section 23 assigns identification information (hereafter referred to as “ID”) to each job to be transmitted to the queue management node 30. The same ID is assigned to a plurality of jobs that are desired to be executed in succession. The ID management section 24 issues an ID in response to a request from the ID assignment section 23 or returns the ID assigned to a job in response to an inquiry. Since the same ID is issued for jobs to be executed in succession, the ID is assumed to be a group ID for the jobs to be executed in succession. The ID management section 24 manages IDs using the ID information storage section 25. The ID information storage section 25 stores ID management information that is generated so that identification information (job ID) for identifying each job is made correspondence with the ID (group ID) assigned to the job by the ID assignment section 23.

The components 21 to 24 of the image forming apparatus 10 are accomplished by the cooperation between the computer incorporated in the image forming apparatus 10 and programs operating on the CPU 11 mounted on the computer. The ID information storage section 25 may also be accomplished by the HDD 18.

The queue management node 30 has a job receiving section 51, a job registration section 52, a job execution instruction section 53, and a job queue 54. The job receiving section 51 receives a job, the execution of which is requested by the image forming apparatus 10. The job registration section 52 registers the job received by the job receiving section 51 in the job queue 54. At that time, the registration section 52 registers the job in correspondence with the ID added to the job. The job execution instruction section 53 sequentially takes out jobs registered in the job queue 54 and issues an execution instruction to any one of the nodes 3.

The components 51 to 53 of the queue management node 30 are accomplished by the cooperation between the computer constituting the queue management node 30 and programs operating on the CPU 31 mounted on the computer. In addition, the job queue 54 may also be accomplished by the HDD 34 mounted on the queue management node 30.

Furthermore, programs to be used in this embodiment can be provided through the communication means as a matter of course and can also be provided as being stored in computer-readable recording media, such as CD-ROMs and DVD-ROMS. The programs provided by the communication means or recording media are installed in the computer, and the installed programs are executed sequentially by the CPU of the computer to execute various kinds of processing.

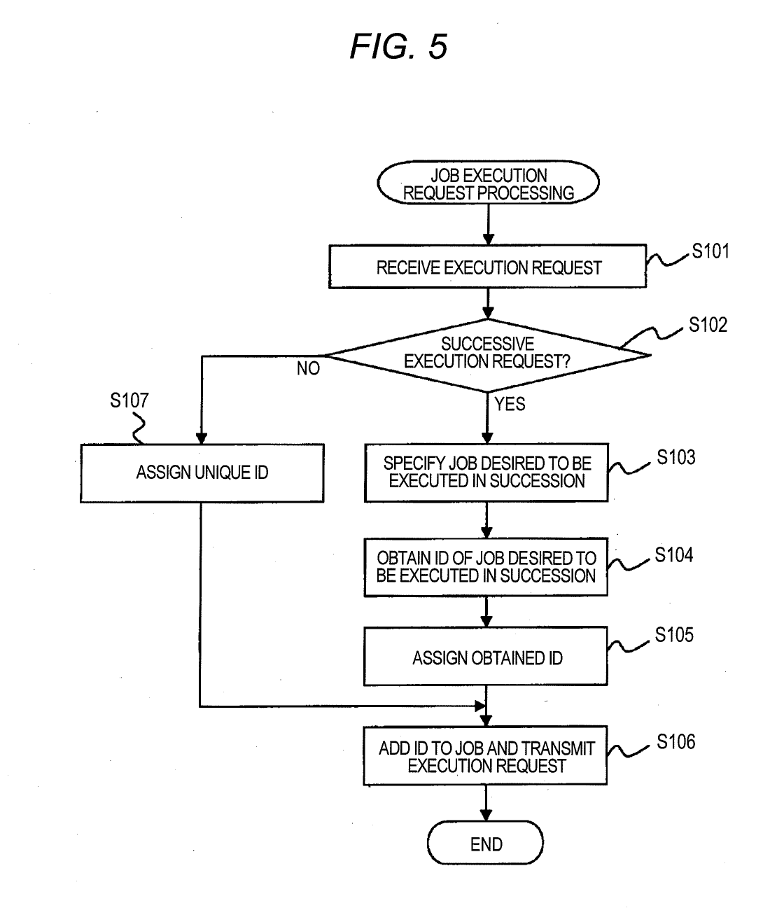

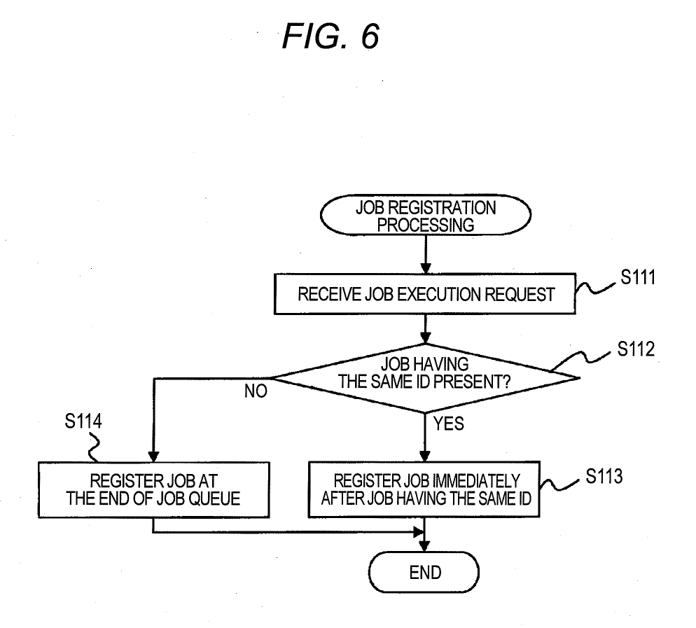

Next, job execution processing according to this embodiment will be described below referring to flowcharts shown in FIGS. 5 and 6.

Referring to FIG. 5, the execution request receiving section 21 of the image forming apparatus 10 receives a job execution request from the user (at step 101). The job execution request may also be made by setting a desired parameter or the like through the operation of the operation panel 12 by the user, for example, by pressing a start button or the like. At this time, a manuscript provided as original data to be processed may be read by the IIT 13. Alternately, the job execution request may also be transmitted together with electronic data to be processed from a personal computer (not shown) or the like by the user via the network.

Then, in the case that the user desires that the job to be requested for execution and a job, the execution request for which has already been transmitted to the queue management node 30, should be executed in succession or that the job to be requested for execution and a job to be transmitted together from now should be executed in succession, the user performs a predetermined instruction operation from the operation panel 12. In the case that this predetermined instruction operation is recognized (Y at step 102), the ID assignment section 23 displays the list of jobs generated in the past on the operation panel 12. Display contents on the operation panel 12 contain information, on the basis of which the user can specify each job by referring to the display contents, for example, identification information, such as the name of a person requesting to execute a job, the date and time of the request and the name of data to be processed for the job. By referring to the display contents, the user selects a job desired to be executed in succession. When the job desired to be executed in succession is specified by this selection (at step 103), the ID assignment section 23 obtains the ID assigned to the job by making an inquiry to the ID management section 24 together with the information for specifying the selected job (at step 104). The obtained ID is assigned to the job to be requested for execution (at step 105). In other words, the same ID is assigned to the jobs to be executed in succession. The ID management section 24 performs registration in the ID information storage section 25 so that the job ID of the job to which the ID is assigned is made correspondence with the ID given to the ID assignment section 23 in response to the inquiry.

On the other hand, in the case that it is recognized that the user does not request that the job to be requested for execution and another job are executed in succession since the operation for successive job execution is not performed (N at step 102), the ID assignment section 23 obtains a unique ID by making an inquiry to the ID management section 24 without transmitting information for specifying a job to be executed in succession. Then, the unique ID is assigned to the job to be requested for execution (at step 107). The ID management section 24 performs registration in the ID information storage section 25 so that the job ID of the job to which the ID is assigned is made correspondence with the unique ID issued for the job.

When the ID to be assigned to the job is specified as described above, the execution request transmission section 22 adds, to the job, the ID assigned to the job and transmits an execution request to the queue management node 30 (at step 106).

Referring to FIG. 6, when the job receiving section 51 of the queue management node 30 receives the job transmitted from the image forming apparatus 10 (at step 111), the job registration section 52 registers the received job (hereafter referred to as “new job”) in the job queue 54. At this time, the job registration section 52 checks whether any job having the same ID as the ID added to the new job has been registered in the job queue 54. In the case that no job having the same ID has been registered (N at step 112), the job registration section 52 registers the new job at the end of the job queue 54 according to a general registration rule (at step 114). At this time, the job registration section 52 registers the new job in the job queue 54 in correspondence with the ID added to the new job.

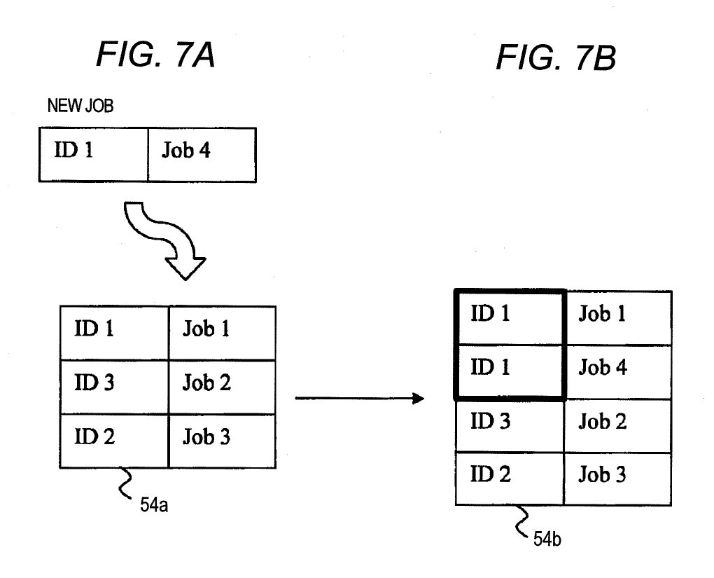

On the other hand, in the case that a job having the same ID has been registered (Y at step 112), the job registration section 52 registers the new job immediately after the job having the same ID (at step 113). Also in this case, the job registration section 52 registers the new job in correspondence with the ID. This processing will be described further referring to FIG. 7.

FIG. 7A shows a job queue 54a before the registration of a new job, and FIG. 7B shows a job queue 54b after the registration of the new job. “ID 1” is added to the new job “Job 4” in this example. Since the new job is basically registered at the end of the job queue 54, the new job is registered at the fourth position immediately after “Job 3” in the case of FIG. 7A. However, in this embodiment, since the job “Job 1” having the same ID as that of the new job has already been registered, the new job is registered immediately after the job “Job 1” having the same ID in this case. As a result, the new job is registered in the job queue 54b such that the new job cuts in the queue and takes the second position immediately after the job “Job 1” as shown in FIG. 7B. Hence, the new job and the job “Job 1” having the same ID are executed in succession

However, even if the execution request for the job “Job 1” and the execution request for the job “job 4” are transmitted in succession from the same image forming apparatus 1, there is a possibility that jobs from other image forming apparatuses 10, such as jobs “Job 2” and “Job 3” in the case of FIGS. 7A and 7B, are received after the job “Job 1” is received and before the job “Job 4” is received, depending on the timing when the queue management node 30 receives the jobs. Even in this case, the queue management node 30 makes an adjustment so that the job “Job 1” and the job “Job 4” are executed in succession by assigning the same ID to the jobs. Even if the image forming apparatus 10 does not transmit the job “Job 1” and the job “job 4” in succession, the job “job 4” is registered immediately after the job “Job 1” during a period in which the job “Job 1” has been registered in the job queue 54. The phrase “immediately after the job having the same ID” means that in the case that only one job having the same ID as that of the new job has been registered in the job queue 54 as in the example shown in FIG. 7A, the new job is registered immediately after the registered job. In the case that a plurality of jobs having the same ID have been registered in the job queue 54, the new job is registered at the end of the group of the jobs having the same ID. Jobs having the same ID and having already been registered should have been registered always in succession by following the processing procedure shown in FIG. 6.

The new job is registered in the job queue 54 as described above. The job execution instruction section 53 fetches jobs in the order stored in the job queue 54 and issues an execution instruction to any one of the nodes 3.

In this embodiment, a unique ID (group ID) for each group of jobs desired to be executed in succession is required to be assigned to the jobs belonging to the group as clearly described above. Hence, it is desirable that the image forming apparatuses 10 included in this system should generate IDs according to the same ID generation rule so that different image forming apparatuses 10 generate the same ID.

Jobs desired to be executed in succession are basically transmitted from the same image forming apparatus to the queue management node 30 as described above. However, it may be possible that, for example, the ID information storage section 25 is shared inside the system so that jobs belonging to the same group, that is, jobs desired to be executed in succession, can be transmitted from different image forming apparatuses 10 to the queue management node 30. More specifically, it may be possible that a certain image forming apparatus 10 obtains the ID assigned to a job requested for execution by another image forming apparatus 10 by referring to the ID information stored in the shared ID information storage section 25 and then assigns the obtained ID to the job to be requested for execution, whereby the jobs requested for execution by different image forming apparatuses 10 are executed in succession.

### Embodiment 2

In Embodiment 1, in the case that a job having the same ID as that of a new job has been registered in the job queue 54, the new job is registered immediately after the job. However, in that case, the execution position of a job having a different ID and having been registered before the registration of the new job is moved down since the new job cuts in the job queue and is registered. Embodiment 2 is devised to adjust the execution positions of all the jobs registered in the job queue 54.

Since the configuration of the job execution system, the block configuration of the system and the processing at the image forming apparatuses 10 may be the same as those according to Embodiment 1, their descriptions are omitted.

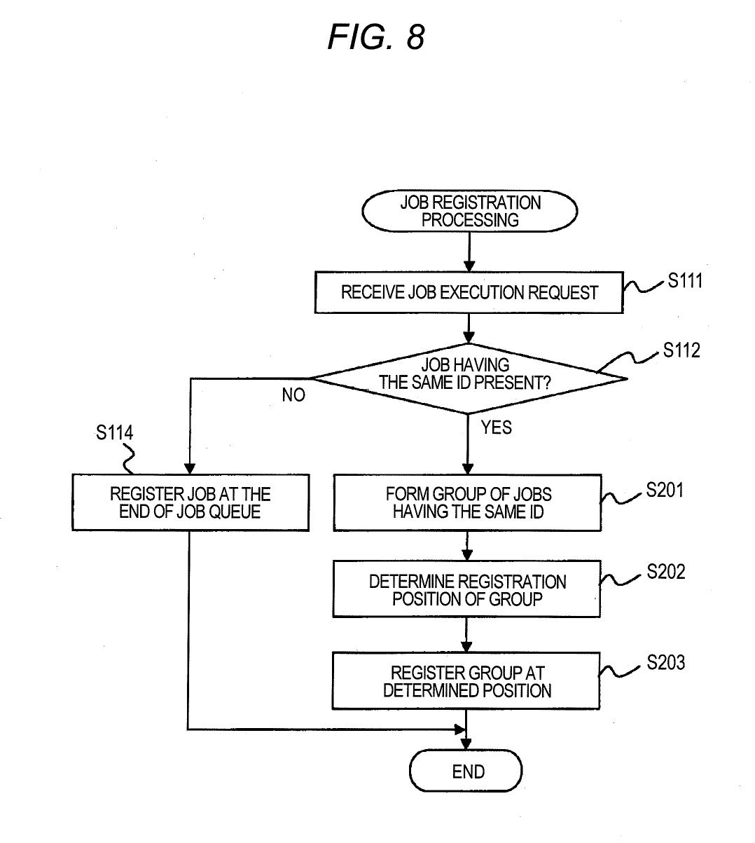

Job execution processing in the queue management node 30 according to this embodiment will be described below referring to the flowchart shown in FIG. 8. Since FIG. 8 is a flowchart corresponding to FIG. 6 according to Embodiment 1, the same processing steps are designated by the same codes, and their descriptions are omitted.

In the case that a job having the same ID as that of a new job has not been registered in the job queue 54 (N at step 112), the job registration section 52 registers the new job at the end of the job queue 54 (at step 114).

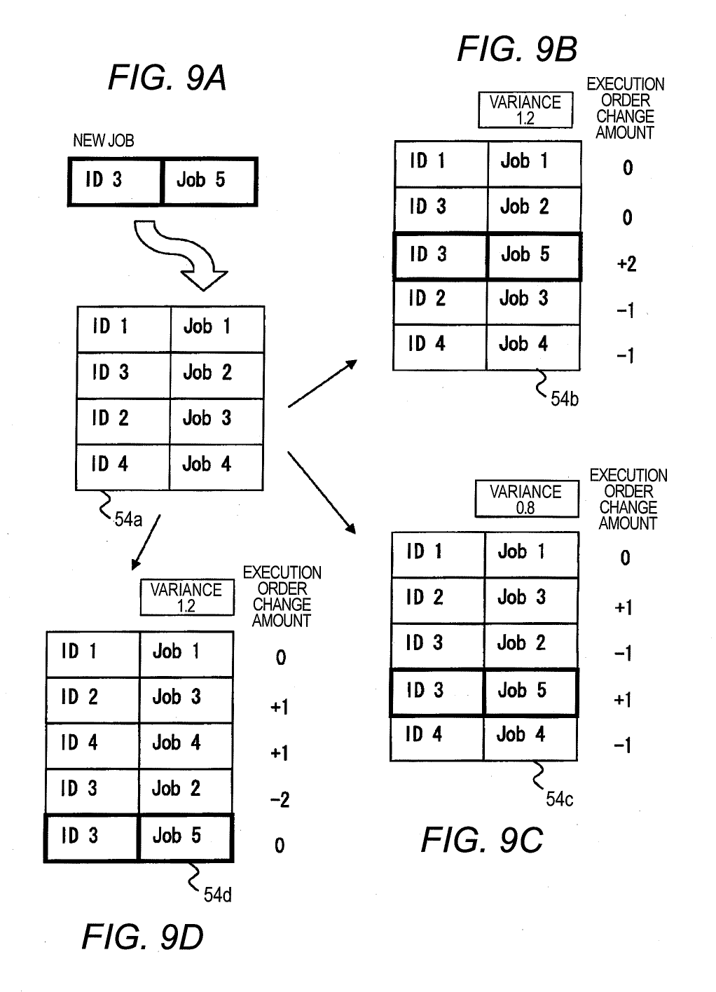

On the other hand, in the case that a job having the same ID as that of the new job has been registered in the job queue 54 (Y at step 112), the job registration section 52 forms a group consisting of the job having the same ID and having already been registered and the new job (at step 201). Then the job registration section 52 determines the position of the formed group in the job queue 54 (at step 202). The processing for determining this registration position will be described referring to FIGS. 9A to 9D.

FIG. 9A shows a job queue 54a before the registration of a new job, and FIG. 9B to 9D show job queues 54b to 54d after the registration of the new job at any one of positions. In this example, “ID 3” is added to the new job “Job 5.” Since the new job is basically registered at the end of the job queue 54, in the case of FIG. 9A, the new job is registered at the fifth position immediately after “Job 4.” However, in this embodiment, since a job “Job 2” having the same ID as that of the new job has already been registered, the new job is disposed immediately after the job “Job 2” having the same ID and is grouped with the job “Job 2” in this case.

FIG. 9B shows a case in which the formed group is registered at the position in which the job “Job 2” has been registered at present. Furthermore, execution order change amounts described below are shown on the right side of the job queue 54b so as to correspond to the respective jobs. Execution order change amounts are also shown in FIGS. 9C and 9D. In the case of FIG. 9B, in comparison with the case in which the new job is registered at the end of the job queue 54, i.e., the fifth position, in principle, the execution positions of the first job “Job 1” and the second job “Job 2” are not moved up or down, but remain unchanged. Hence, the execution order change amounts of these two jobs are 0. Next, although the new job “Job 5” is supposed to be positioned essentially at the end of the job queue 54, i.e., the fifth position, the execution position of the new job is moved up by two positions to the third position, and the new job is registered at the position. Hence, the execution order change amount of the new job “Job 5” becomes +2. Next, although jobs “Job 3” and “Job 4” are supposed to be positioned essentially at the third and fourth positions of the job queue 54, when the new job “Job 5” is registered at the third position, the execution positions of the jobs “Job 3” and “Job 4” are respectively moved down by one position. In other words, the execution order change amounts of the jobs “Job 3” and “Job 4” become −1. FIG. 9B shows the execution order change amounts obtained as described above. When the new job “Job 5” is registered in the job queue 54 so as to cut in the queue as described above, the execution positions of some jobs are changed. In other words, the registration positions of the jobs in the job queue 54 are changed.

After the execution order change amounts of the respective jobs are obtained as described above, an index value indicating the execution order change amounts before and after the change in execution order is calculated. In this embodiment, the index value is calculated using variance. For example, since the average value of the execution order change amounts in FIG. 9B is 0, the index value in case of FIG. 9B is calculated as follows: {(0−0)²+(0−0)²+(2−0)²+(−1−0)²+(−1−0)²}/5=1.2

Next, the case of FIG. 9C will be described below. Although the group “ID 3” in FIG. 9B is registered at the position of the job “Job 2,” FIG. 9C shows an example in which the execution position of the group “ID 3” is moved down by one position and the group “ID 3” is registered at the position. In the case of FIG. 9C, in comparison with the case in which the new job is registered at the end of the job queue 54, i.e., the fifth position, in principle, the execution position of the first job “Job 1” remains unchanged, and its execution order change amount is 0. The execution position of the job “Job 3” is moved up by one position from the third position to the second position, and its execution order change amount becomes +1. On the other hand, the execution position of the job “Job 2” is moved down by one position from the second position to the third position, and its execution order change amount becomes −1. The new job “Job 5” is supposed to be positioned essentially at the end of the job queue 54, i.e., the fifth position, the execution position of the new job is moved up by one position to the fourth position, and its execution order change amount becomes +1. Furthermore, although the job “Job 4” is supposed to be positioned essentially at the fourth position, since its execution position is moved down by one position to the fifth position, its execution order change amount becomes −1. FIG. 9C shows the execution order change amounts obtained as described above.

The index value indicating the change amounts before and after the change in the case of FIG. 9C is calculated according to the calculation method described in the case of FIG. 9B as follows: {(0−0)²+(1−0)²+(−1−0)²+(1−0)²+(−1−0)²}/5=0.8

Next, FIG. 9D shows an example in which the execution position of the group “ID 3” is moved down further by one position and the group “ID 3” is registered at the end of the job queue 54. In the case of FIG. 9D, since the execution order change amounts can be calculated similarly as described above, the detailed descriptions thereof are omitted. FIG. 9D shows the results of the execution order change amounts of the respective jobs when the registration state of the job queue 54 is as shown in FIG. 9D. The index value indicating the change amounts before and after the change in the case of FIG. 9D is calculated as follows: {(0−0)²+(1−0)²+(1−0)²+(−2−0)²+(0−0)²}/5=1.2

In the case that the group “ID 3” is registered at any one of the positions in the job queue 54 as described above and when the obtained index values indicating the change amounts before and after the change are compared with one another, the index value in the case that the group “ID 3” is registered at the position shown in FIG. 9C, the index value becomes minimal. In other words, when the group “ID 3” is registered at this position, the change amount for all the jobs registered in the job queue 54 becomes smallest, and it is judged that the position is optimal.

When the registration position of the group “ID 3” is determined as described above, the job registration section 52 actually registers the job “Job 2” and the new job “Job 5” belonging to the group “ID 3” at the determined position (at step 203).

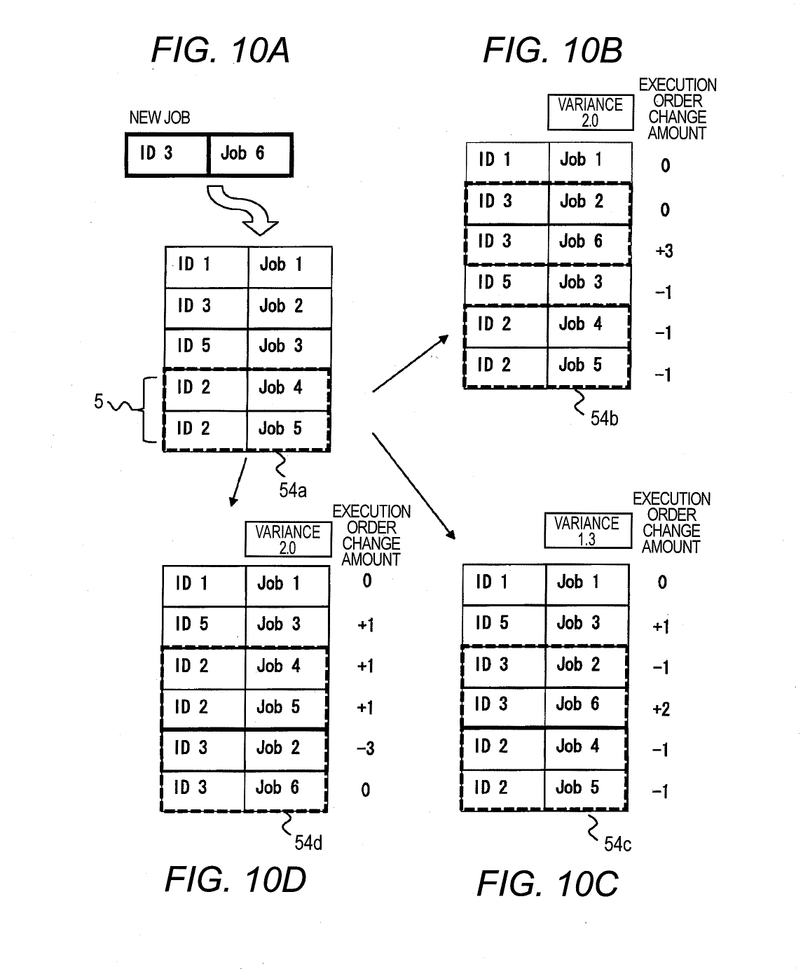

Unlike FIGS. 9A to 9D, FIGS. 10A to 10D show an example in which another group 5 has already been formed and registered in the job queue 54. In this case, the operation of the job registration section 52 may be the same as that shown in FIGS. 9A to 9D. In the case shown in FIGS. 9B to 9D, the execution position of the group “ID 3” is moved down by one position at a time from the registration position of the job “Job 2” having already been registered in the job queue 54 and the index values are calculated. However, in the case that the other group 5 has been registered in the job queue 54 as shown in FIG. 10A, the index value is not calculated in a state in which the group “ID 3” cuts in the other group 5. In other words, in the case that the group “ID 3” is registered at the registration position of a job “Job 2” having already been registered in the job queue 54 as shown in FIG. 10B, and in the case that the group “ID 3” is moved down by one position as shown in FIG. 10C from the registration position shown in FIG. 10B, processing similar to that carried out in the cases of FIGS. 9B to 9D should only be carried out up to the calculation of the respective index values. Furthermore, in the cases of FIGS. 10B to 10D, for example, as shown in FIG. 10D, the group “ID 3” does not cut in the group 5 consisting of jobs “Job 4” and “Job 5” but is moved down to the position under the group 5 and registered at the position, and the index value in this case is calculated.

The methods for calculating the execution order change amounts and the index value indicating the change amounts before and after the change are as described above referring to FIG. 9A to 9D, and the descriptions of the methods are omitted. In the example shown in FIGS. 10B to 10D, it is optimal that the group “ID 3” is registered at the position shown in FIG. 10C.

In FIGS. 9B to 9D and FIGS. 10B to 10D, the index value is calculated at all the positions where the group “ID 3” can be registered. However, in the case that the index value is calculated using variance, it is assumed that the index value increases as the registration position of the group “ID 3” is moved away from the optimal position (the position in which the index value becomes minimal). Hence, the index value calculated when the group “ID 3” is registered at a certain position (pth position) is smaller than the index value calculated in the case that the group “ID 3” is registered at a position adjacent to either one of both sides of the position ((p+1)th and (p−1)th positions in the case that no group exists on both sides of the position), the pth position is obtained as the optimal position as the registration position of the group “ID 3.” In other words, it is not necessary to calculate the index value at all the registration positions in the job queue 54.

In this embodiment, variance is used to calculate the index value indicating the change amounts before and after the change. However, the registration position of a group may also be determined on the basis of other index values. For example, the absolute maximum value of the execution order change amount is calculated as an index value indicating the change in execution order and the group is registered at a position in which the index value becomes minimal.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A job execution system comprising:
one or more transmission apparatuses that add identification information for identifying a group of jobs to be executed in succession to a job and that transmits an execution request of the job with the identification information; and
a job receiving apparatus that receives the execution request of the job transmitted by the transmission apparatus, wherein
the job receiving apparatus includes:
a job queue; and
a job registration unit that makes a correspondence between the received execution request of the job and the identification information added to the job, and that registers said received execution request of the job and said identification information in the job queue,
when the received execution request of the job has the same identification information which is previously registered in the job queue, the job registration unit registers the received execution request of the job immediately after another execution request of a job having the same identification information.

2. The job execution system according to claim 1, wherein
when execution positions of execution requests of jobs which are previously registered in the job queue are changed by registering the received execution request of the job immediately after another execution request of a job having the same identification information,
the job registration unit calculates index values which indicate execution order change amounts before and after the execution positions are changed, and
the job registration unit registers both the execution request of the job having the same identification information and the received execution request of the job at the positions in the job queue determined based on the calculated index values.

3. The job execution system according to claim 1, wherein
the transmission apparatus generates identification information management information by making a correspondence between the job and the identification information added to the job,
the identification information management information is referred to from a plurality of transmission apparatuses, and
the job execution system further comprises a storage apparatus that stores the identification information management information, and
the transmission apparatus adds identification information contained in the identification information management information stored in the storage apparatus to a target execution request of a job.

4. A job receiving apparatus comprising:
a receiving unit that receives a execution request of a job to which identification information for identifying a group of jobs to be executed in succession is added; and
a job registration unit that makes a correspondence between the received execution request of the job and the identification information added to the job, and that registers said received execution request of the job and said identification information in a job queue, wherein
when the received execution request of the job has the same identification information which is previously registered in the job queue, the job registration unit registers the received execution request of the job immediately after another execution request of a job having the same identification information.

5. A non-transitory computer-readable medium storing a program that causes a computer to executes job execution, the job execution comprising:
receiving a execution request of a job to which identification information for identifying a group of jobs to be executed in succession is added;
making a correspondence between the received execution request of the job and the identification information added to the job; and
registering said received execution request of the job and said identification information in a job queue, and
registering the received execution request of the job immediately after another execution request of a job having the same identification information which is previously registered in the job queue when the received execution request of the job has the same identification information.
